(19) United States
(12) Patent Application Publication
(10) Pub. No.: US 2023/0246467 A1
(43) Pub. Date: Aug. 3, 2023

(54) SYSTEMS AND METHODS FOR PRIORITIZING POWER FLOW BETWEEN ELECTRIFIED VEHICLES AND CHARGING TRAILERS

(71) Applicant: FORD GLOBAL TECHNOLOGIES, LLC, Dearborn, MI (US)

(72) Inventors: Stuart C. SALTER, White Lake, MI (US); Ryan O'GORMAN, Beverly Hills, MI (US); William David TREHARNE, Ypsilanti, MI (US); Lorne FORSYTHE, Novi, MI (US); Peter PHUNG, Windsor (CA); William WURZ, San Francisco, CA (US); Clive MCKENZIE, Plymouth, MI (US)

(21) Appl. No.: 17/590,113

(22) Filed: Feb. 1, 2022

(51) Int. Cl. H02J 7/00; B60L 50/60; B60L 58/10; B60L 53/67; B60L 53/66

(52) U.S. Cl. CPC H02J 7/007; B60L 50/60; B60L 58/10; B60L 53/67; B60L 53/66; H02J 7/00036

(57) ABSTRACT

Systems and methods are provided for coordinating and controlling power flow during bidirectional energy transfer events between an electrified vehicle and one or more charging trailers. The systems and methods may prioritize energy transfers between each connected energy unit based on various parameters, including but not limited to battery prognostic information, driving habits/predicted behavior, user preferences, etc. Charge energy may be transferred to the appropriate energy unit using a semi-automated approach to meet customer needs with varying levels of priority according to an energy transfer prioritization control strategy that is derived from the various inputs that are considered.

### TECHNICAL FIELD

This disclosure relates generally to systems and methods for providing prioritized bidirectional energy transfers between charging trailers and electrified vehicles.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine. Plug-in type electrified vehicles include one or more charging interfaces for charging the traction battery pack. Plug-in type electrified vehicles are most commonly charged while parked at a charging station or some other utility power source.

### SUMMARY

A bidirectional energy transfer system according to an exemplary aspect of the present disclosure includes, among other things, an electrified vehicle, a charging trailer operably coupled to the electrified vehicle, and a control module programmed to create an energy transfer prioritization control strategy for controlling a transfer of energy between the electrified vehicle and the charging trailer during an energy transfer event.

In a further non-limiting embodiment of the forgoing system, an electrified recreational/industrial vehicle is operably coupled to the charging trailer.

In a further non-limiting embodiment of either of the foregoing systems, the control module is further programmed to control a transfer of energy from at least one of the charging trailer or the electrified vehicle to the electrified recreational/industrial vehicle during the energy transfer event.

In a further non-limiting embodiment of any of the foregoing systems, the control module is further programmed to interface with a bidirectional power transfer system of the electrified vehicle for controlling the transfer of the energy between the charging trailer and the electrified vehicle according to the energy transfer prioritization control strategy during the energy transfer event.

In a further non-limiting embodiment of any of the foregoing systems, the control module is a component of the electrified vehicle.

In a further non-limiting embodiment of any of the foregoing systems, the control module is a component of a cloud-based server system.

In a further non-limiting embodiment of any of the foregoing systems, the energy transfer prioritization control strategy includes a first priority ranking score assigned to a traction battery pack of the electrified vehicle and a second priority ranking score assigned to an energy storage system of the charging trailer.

In a further non-limiting embodiment of any of the foregoing systems, the energy transfer prioritization control strategy includes a third priority ranking score assigned to either a second charging trailer or an electrified recreational/industrial vehicle that is operably coupled to the charging trailer.

In a further non-limiting embodiment of any of the foregoing systems, the energy transfer prioritization control strategy is derived based on battery prognostic information associated with a traction battery pack of the electrified vehicle and an energy storage system of the charging trailer.

In a further non-limiting embodiment of any of the foregoing systems, the energy transfer prioritization control strategy is further derived based on environmental information and/or itinerary/calendar information associated with a user of the electrified vehicle.

An electrified vehicle according to another exemplary aspect of the present disclosure includes, among other things, a traction battery pack and a control module programmed to create an energy transfer prioritization control strategy for controlling a transfer of energy from the traction battery pack to a separate energy unit or from the separate energy unit to the traction battery pack during an energy transfer event.

In a further non-limiting embodiment of the foregoing electrified vehicle, the energy transfer prioritization control strategy includes a priority ranking score assigned to the traction battery pack.

In a further non-limiting embodiment of either of the foregoing electrified vehicle systems, the energy transfer prioritization control strategy is derived based on battery prognostic information associated with the traction battery pack.

In a further non-limiting embodiment of any of the foregoing electrified vehicle systems, the energy transfer prioritization control strategy is derived based on real-time prognostic information associated with the electrified vehicle.

In a further non-limiting embodiment of any of the foregoing electrified vehicle systems, the energy transfer prioritization control strategy is derived based on itinerary/calendar information associated with a user of the electrified vehicle.

In a further non-limiting embodiment of any of the foregoing electrified vehicle systems, the energy transfer prioritization control strategy is derived based on a real-time weather condition.

In a further non-limiting embodiment of any of the foregoing electrified vehicle systems, the energy transfer prioritization control strategy is derived based on a real-time traffic condition.

In a further non-limiting embodiment of any of the foregoing electrified vehicle systems, the energy transfer prioritization control strategy is derived based on user preference information that is pre-selected by a user of the electrified vehicle.

In a further non-limiting embodiment of any of the foregoing electrified vehicle systems, the control module is further programmed to transmit a charge priority report to a user of the electrified vehicle in anticipation of the energy transfer event.

In a further non-limiting embodiment of any of the foregoing electrified vehicle systems, the control module is further programmed to receive an input from the user indicating a modification to the charge priority report.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a bidirectional energy transfer system configured for transferring energy between an electrified vehicle and one or more charging trailers.

FIG. 2 schematically illustrates exemplary aspects of a bidirectional energy transfer system from the perspective of an electrified vehicle of the system.

FIG. 3 schematically illustrates an exemplary charge priority report that can be displayed to a user on a user interface associated with a bidirectional energy transfer system.

FIG. 4 schematically illustrates a control system of another exemplary bidirectional energy transfer system.

FIG. 5 is a flow chart of an exemplary method for coordinating and controlling prioritized bidirectional energy transfers between an electrified vehicle and one or more charging trailers of a bidirectional energy transfer system.

FIG. 6 schematically illustrates an exemplary power flow topology of a bidirectional energy transfer system.

### DETAILED DESCRIPTION

This disclosure relates to systems and methods for coordinating and controlling power flow during bidirectional energy transfer events between an electrified vehicle and one or more charging trailers. The systems and methods may prioritize energy transfers between each connected energy unit based on various parameters, including but not limited to battery prognostic information, driving habits/predicted behavior, user preferences, etc. Charge energy may be transferred to the appropriate energy unit using a semi-automated approach to meet customer needs with varying levels of priority according to an energy transfer prioritization control strategy that is derived from the various inputs that are considered. These and other features of this disclosure are discussed in greater detail in the following paragraphs of this detailed description.

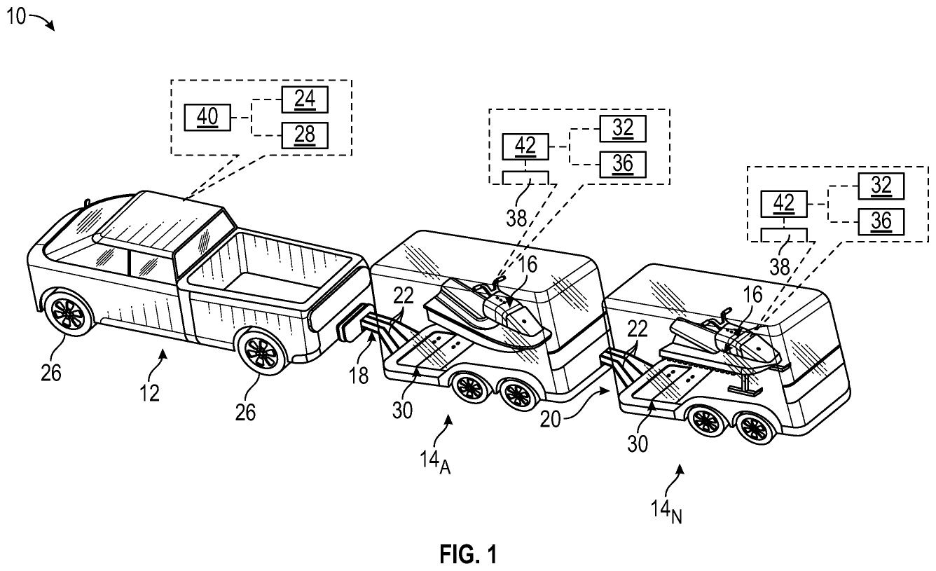

FIG. 1 schematically illustrates an exemplary bidirectional energy transfer system 10 (hereinafter “the system 10”) for bidirectionally transferring energy between multiple electrified units. In particular, the system 10 may be utilized for controlling the power flow between a towing or leading electrified vehicle 12 and one or more charging trailers 14A to 14N, where “N” represents any number. The charging trailers 14 may be operably connected in series to the electrified vehicle 12. Unless stated otherwise herein, reference numeral “14” may refer to any of the charging trailers when used without any alphabetic identifier immediately following the reference numeral.

Energy may be bidirectionally transferred between the electrified vehicle 12 and the one or more charging trailers 14 either while the structures are stationary or during “in-flight” events. In this disclosure, the term “in-flight” means during the coupled movement of the electrified vehicle 12 and the one or more charging trailers 14, such as when the electrified vehicle 12 is hauling or towing the one or more charging trailers 14. Accordingly, the system 10 is capable of effectively managing the bidirectional transfer of energy from the electrified vehicle 12 to the one or more charging trailers 14 or vice-versa while the respective electrified units are making forward progress toward a desired destination/waypoint.

The charging trailers 14 may be coupled to the electrified vehicle 12 in a daisy-chain configuration. For example, a first towing device 18 may releasably couple the charging trailer 14_{A} to the electrified vehicle 12, a second towing device 20 may releasably couple the charging trailer 14_{N} to the charging trailer 14_{A}, and so on for enabling a towing event in which energy transfers between the various energy units can be executed. Each towing device 18, 20 may include electrical cabling 22 for enabling energy transfers between the various energy units of the system 10. The specific configuration of each towing device 18, 20 is not intended to limit this disclosure.

Each charging trailer 14 may optionally haul/store/house one or more electrified recreational/industrial vehicles 16. The system 10 may thus be configured for achieving bidirectional energy transfers between each of the electrified vehicle 12, the one or more charging trailers 14, and the one or more electrified recreational/industrial vehicles 16. Although one electrified vehicle 12, two charging trailers 14, and two electrified recreational/industrial vehicles 16 are illustrated as being part of the system 10 of FIG. 1, this disclosure is not limited to that specific configuration of the system 10.

The electrified vehicle 12 of FIG. 1 is schematically illustrated as a pickup truck. However, other electrified vehicle configurations are also contemplated. The teachings of this disclosure may be applicable for any type of vehicle as the electrified vehicle 12. For example, the electrified vehicle 12 could be configured as a car, a truck, a van, a sport utility vehicle (SUV), etc.

The electrified recreational/industrial vehicle 16 of the charging trailer 14_{A} is schematically illustrated as a personal watercraft, and the electrified recreational/industrial vehicle 16 of the charging trailer 14_{N} is schematically illustrated as a snowmobile. However, other recreational/industrial vehicle configurations are also contemplated. The teachings of this disclosure may be applicable for any type of recreational/industrial vehicle. For example, the one or more electrified recreational/industrial vehicles 16 could include any combination of all-terrain vehicles (ATV), utility vehicles (UTV), motorcycles, bikes, dirt bikes, snowmobiles, off-road vehicles, personal watercrafts, etc. Moreover, the term “electrified recreational/industrial vehicle” is additionally inclusive of industrial/commercial equipment and related vehicles such as agricultural equipment (e.g., various tractors, backhoes, harvesters, drones, etc.) and/or construction equipment (e.g., towable light towers, skid-steer/compact track and various loaders, forklifts/telehandlers, mini excavators, boom/scissor and various lifts, carry deck cranes, trenchers, pavers, compactors, dozers, drum rollers, drones, etc.).

In an embodiment, the electrified vehicle 12 is a plug-in type electrified vehicle (e.g., a plug-in hybrid electric vehicle (PHEV) or a battery electric vehicle (BEV)). The electrified vehicle 12 may include an electrified powertrain capable of applying a torque from an electric machine 24 (e.g., an electric motor) for driving one or more drive wheels 26 of the electrified vehicle 12. The electrified vehicle 12 may include a traction battery pack 28 for powering the electric machine 24 and other electrical loads of the electrified vehicle 12. The powertrain of the electrified vehicle 12 may electrically propel the drive wheels 26 either with or without the assistance of an internal combustion engine.

In an embodiment, each charging trailer 14 may include an energy storage system 30 adapted for storing electrical energy that can be utilized to charge the electrified vehicle 12 and/or one or more of the electrified recreational/industrial vehicles 16. Each energy storage system 30 may include in an exemplary embodiment a battery bank having a plurality of interconnected battery cells capable of storing electrical energy. However, other types of energy storage devices are also contemplated within the scope of this disclosure.

In an embodiment, each electrified recreational/industrial vehicle 16 is an all-electric recreational/industrial vehicle having an electrified powertrain capable of applying torque from an electric machine 32 (e.g., an electric motor) for driving one or more drive devices (e.g., wheel, pump, etc.) of the electrified recreational/industrial vehicle 16. Each electrified recreational/industrial vehicle 16 may further include a traction battery pack 36 for powering the electric machine 32. The powertrain of each electrified recreational/industrial vehicle 16 may electrically propel the drive device without the assistance of an internal combustion engine.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component.

Although shown schematically, the traction battery pack 28 of the electrified vehicle 12 may be configured as a high voltage traction battery pack that includes a plurality of battery arrays (i.e., battery assemblies or groupings of battery cells) capable of outputting electrical power to the electric machine 24 of the electrified vehicle 12. Other types of energy storage devices and/or output devices may also be used to electrically power the electrified vehicle 12.

The traction battery pack 36 of each electrified recreational/industrial vehicle 16 may be a removable high voltage traction battery that includes a plurality of battery cells or groupings of battery cells. In an embodiment, each traction battery pack 36 is a removable traction battery that may be swapped out and replaced with another traction battery.

In some implementations, the traction battery pack 36 of each electrified recreational/industrial vehicle 16 is a smaller battery than the traction battery pack 28 of the electrified vehicle 12. However, both batteries are capable of supplying high voltage power for electrically propelling the electrified vehicle 12 or the respective electrified recreational/industrial vehicle 16. From time to time, the traction battery pack 28 and/or the traction battery pack 36 must be recharged to replenish their respective energy stores. As further discussed below, the system 10 may be configured to coordinate and control the exchange of charge energy between various energy units of the system 10.

The electrified vehicle 12 may additionally include a bidirectional power transfer system 40. The bidirectional power transfer system 40 may be configured for enabling the bidirectional transfer of power to/from the electrified vehicle 12. The electric machine 24 and the bidirectional power transfer system 40 may collectively be referred to as an electric power take-off of the electrified vehicle 12.

The bidirectional power transfer system 40 may be operably connected between the charging trailer 14_{A} and the traction battery pack 28 of the electrified vehicle 12. The bidirectional power transfer system 40 may include various equipment, such as a charger, a DC-DC converter, HV relays or contactors, a motor controller (which may be referred to as an inverter system controller or ISC), etc., arranged and configured to establish the bidirectional transfer of electrical energy between the traction battery pack 28 and another energy source (e.g., the energy storage system 30 of any charging trailer 14 and/or the traction battery pack 36 of any electrified recreational/industrial vehicle 16). The bidirectional power transfer system 40 may additionally be configured to transfer energy between the traction battery pack 28 and the electric machine 24.

Each electrified recreational/industrial vehicle 16 may additionally include a bidirectional power transfer system 42. The bidirectional power transfer system 42 may be operably connected between a charging interface 38 and the traction battery pack 36 of the electrified recreational/industrial vehicle 16. Each electrified recreational/industrial vehicle 16 may interface with the energy storage system 30 of its respective charging trailer 14 through the charging interface 38 for transferring energy between the traction battery pack 36 and the energy storage system 30. The charging interface 38 may be either a wired interface or a wireless interface.

The bidirectional power transfer system 42 may include various equipment, such as a charger, a DC-DC converter, HV relays or contactors, a motor controller (which may be referred to as an inverter system controller or ISC), etc., arranged and configured to establish the bidirectional transfer of electrical energy between the traction battery pack 36 and another energy source (e.g., the energy storage system 30 of a respective charging trailer 14 and/or the traction battery pack 28 of the electrified vehicle 12). The bidirectional power transfer system 42 may additionally be configured to transfer energy between the traction battery pack 36 and the electric machine 32 of each electrified recreational/industrial vehicle 16.

One non-limiting example of a suitable bidirectional power transfer system that may be employed for use within the electrified vehicle 12 and/or the electrified recreational/industrial vehicles 16 for achieving bidirectional power transfers is disclosed within U.S. Patent Publication No. 2020/0324665, assigned to Ford Global Technologies, LLC, the disclosure of which is incorporated by reference herein. However, other bidirectional power transfer systems could also be utilized for achieving the bidirectional transfers of power within the scope of this disclosure.

The system 10 may further be configured to provide “passthrough charging” such that charge energy from the charging trailer 14_{N} and/or the electrified recreational/industrial vehicle 16 of the charging trailer 14_{N} may be passed through the charging trailer 14_{A} for charging the traction battery pack 28, or vice versa. In this disclosure, the term “passthrough charging” indicates the ability of an energy unit to transfer all or a portion of the power stored therein to another energy unit for addressing that unit's energy needs without the other unit being directly connected to the unit that is providing the charge energy.

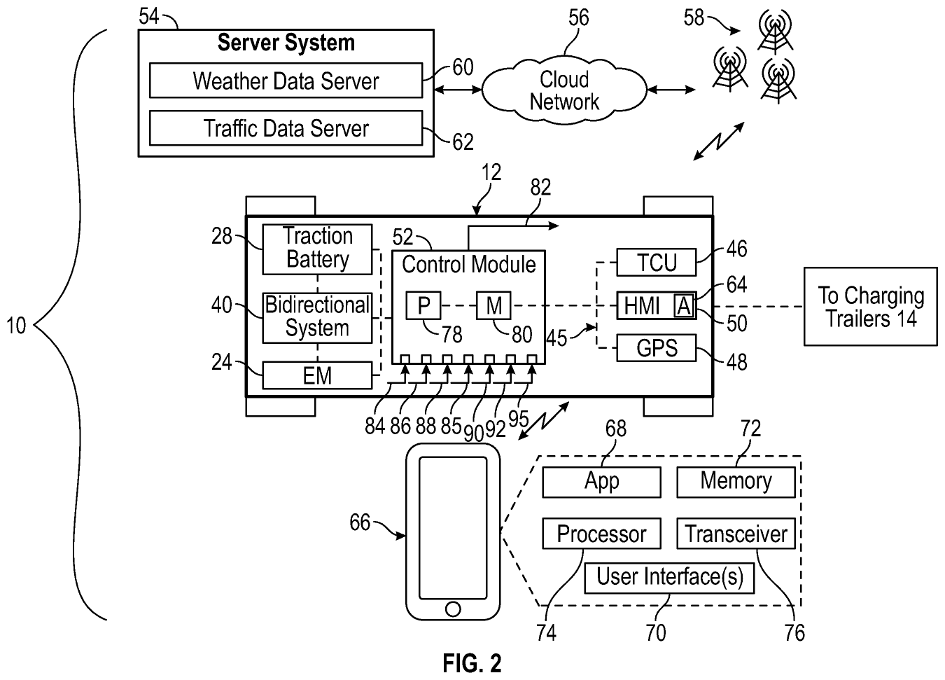

Additional aspects of the system 10 of FIG. 1 are further detailed from the perspective of the electrified vehicle 12 in FIG. 2. In particular, FIG. 2 schematically illustrates features that enable the system 10 to coordinate and provide energy flow prioritization between the electrified vehicle 12 and one or more charging trailers 14 (and/or optionally one or more electrified recreational/industrial vehicles 16) based on an energy transfer prioritization control strategy that may be derived by analyzing various input parameters. In this way, the system 10 may be equipped to effectively manage energy transfers in order of priority between various electrified units.

As further part of the system 10, the electrified vehicle 12 may include a telecommunications module 46, a global positioning system (GPS) 48, a human machine interface (HMI) 50, and a control module 52. These and other components may be interconnected and in electronic communication with one another over a communication bus 45 of the electrified vehicle 12. The communication bus 45 may be a wired communication bus such as a controller area network (CAN) bus, or a wireless communication bus such as Wi-Fi, Bluetooth®, Ultra-Wide Band (UWB), etc.

The telecommunications module 46 may be configured for achieving bidirectional communications with a cloud-based server system 54, for example. The telecommunications module 46 may communicate over a cloud network 56 (e.g., the internet) to obtain various information stored on the server system 54 or to provide information to the server system 54 that can subsequently be accessed by the electrified vehicle 12 (and/or other participating units of the system 10). The server system 54 can identify, collect, and store user data associated with the electrified vehicle 12 for validation purposes. Upon an authorized request, data may be subsequently transmitted to the telecommunications module 46 via one or more cellular towers 58 or some other known communication technique (e.g., Wi-Fi, Bluetooth®, data connectivity, etc.). The telecommunications module 46 can receive data from the server system 54 or can communicate data back to the server system 54 via the cellular tower(s) 58. Although not necessarily shown or described in this highly schematic embodiment, numerous other components may enable bidirectional communications between the electrified vehicle 12 and the server system 54.

The server system 54 may include various servers that store data that may be accessed by the system 10 for coordinating energy transfers between the electrified vehicle 12 and the one or more charging trailers 14 (and/or optionally the one or more electrified recreational/industrial vehicles 16). In an embodiment, the server system 54 includes a weather data server 60 that stores weather related data. The weather related data may include, but is not limited to, region specific weather history for a given locational area, storm metrics including current and forecasted windspeeds, current and forecasted rain fall or snowfall, current and forecasted temperatures, current and forecasted barometric pressures, presence and/or likelihood of extreme weather (e.g., heat waves, tornados, hurricanes, heavy snow fall/blizzards, wild fires, torrential rain falls, etc.), and current and forecasted trajectory of storms for any given location.

The weather data server 60 may be operated or managed, for example, by an organization such as the national weather service. Alternatively, the weather data server 60 may collect weather/climate related data from weather stations, news stations, remote connected temperature sensors, connected mobile device database tables, etc. The weather related data stored on the weather data server 60 could also be derived from crowd sourced weather information.

In another embodiment, the server system 54 includes a traffic data server 62. The traffic data server 62 may store data related to up-to-date traffic conditions associated with the roadways for any given location. The traffic related data may include, but is not limited to, traffic congestion information, emergency service dispatch information, etc. The traffic related data stored on the traffic data server 62 could be derived based on news feed information or crowd sourced information.

In a first embodiment, a user/owner of the electrified vehicle 12 may interface with the server system 54 using the HMI 50. For example, the HMI 50 may be equipped with an application 64 (e.g., FordPass™ or another similar web-based application) for allowing users to interface with the server system 54. The HMI 50 may be located within a passenger cabin of the electrified vehicle 12 and may include various user interfaces for displaying information to the vehicle occupants and for allowing the vehicle occupants to enter information into the HMI 50. The vehicle occupants may interact with the user interfaces presentable on the HMI 50 via touch screens, tactile buttons, audible speech, speech synthesis, etc.

In another embodiment, the user/owner of the electrified vehicle 12 may alternatively or additionally interface with the server system 54 for coordinating functions of the system 10 using a personal electronic device 66 (e.g., a smart phone, tablet, computer, wearable smart device, etc.). The personal electronic device 66 may include an application 68 (e.g., FordPass™ or another similar application) that includes programming to allow the user to employ one or more user interfaces 70 for setting or controlling certain aspects of the system 10. The application 68 may be stored in a memory 72 of the personal electronic device 66 and may be executed by a processor 74 of the personal electronic device 66. The personal electronic device 66 may additionally include a transceiver 76 that is configured to communicate with the server system 54 over the cellular tower(s) 58 or some other wireless link.

The GPS 48 is configured to pinpoint locational coordinates of the electrified vehicle 12. The GPS 48 may utilize geopositioning techniques or any other satellite navigation techniques for estimating the geographic position of the electrified vehicle 12 at any point in time. GPS data from the GPS 48 may be used to determine the weather and traffic data that is most relevant to the electrified vehicle 12 at any point in time, in an embodiment. In another embodiment, data from the GPS 48 may be utilized to identify elevation/terrain variations along a given drive route.

The control module 52 may include both hardware and software and could be part of an overall vehicle control system, such as a vehicle system controller (VSC), or could alternatively be a stand-alone controller separate from the VSC. In an embodiment, the control module 52 is programmed with executable instructions for interfacing with and commanding operations of various components of the system 10. Although shown as separate modules within the highly schematic depiction of FIG. 2, the telecommunications module 46, the GPS 48, the HMI 50, and the control module 52 could be integrated together as part of common module of the electrified vehicle 12.

The control module 52 may include a processor 78 and non-transitory memory 80 for executing various control strategies and modes associated with the system 10. The processor 78 may be a custom made or commercially available processor, a central processing unit (CPU), or generally any device for executing software instructions. The memory 80 may include any one or combination of volatile memory elements and/or nonvolatile memory elements.

The processor 78 may be operably coupled to the memory 80 and may be configured to execute one or more programs stored in the memory 80 of the control module 52 based on the various inputs received from other devices, such as the server system 54, the telecommunications module 46, the GPS 48, the HMI 50, the traction battery pack 28, the energy storage system 30 of each of the one or more charging trailers 14, the one or more electrified recreational/industrial vehicles 16, etc. In an embodiment, the application 64 (e.g., FordPass™ or another similar application), which includes programming for allowing the vehicle user to employ one or more user interfaces within the HMI 50 for setting or controlling certain aspects of the system 10, may be stored in the memory 80 and may be executed by the processor 78 of the control module 52. Alternatively or additionally, the control module 52 may be configured to communicate and interface with the personal electronic device 66 for coordinating and/or executing certain aspects of the system 10 through the application 68.

The control module 52 may receive and process various inputs for creating an energy transfer prioritization control strategy 82 for controlling the transfer of energy between each of the electrified vehicle 12 and the one or more charging trailers 14 (and/or optionally one or more electrified recreational/industrial vehicles 16). The energy transfer prioritization control strategy 82 may include, among other information, notifications, protocols, and level of priority for transferring or receiving energy at each energy unit (e.g., the traction battery pack 28 of the electrified vehicle 12 and the energy storage system 30 of each charging trailer 14) associated with the system 10 during energy transfer events.

A first input that may be analyzed by the control module 52 for developing the energy transfer prioritization control strategy 82 may include battery prognostic information 84 received from each energy unit of the system 10. The battery prognostic information 84 may include information such as current state of charge (SOC), estimated travel range, depth of discharge (DOD) mapping, internal resistance, current battery cell temperatures, and other battery metrics (e.g., voltage, current, battery size, battery type/chemistry, charge rate levels, charge acceptance levels, battery cell aging information, etc.) associated with the traction battery pack 28 of the electrified vehicle 12. Similar battery-related data may also be received from each energy storage system 30 of each connected charging trailer 14 (and optionally from each traction battery pack 36 of each connected electrified recreational/industrial vehicle 16 to the extent any are connected).

A second input that may be analyzed by the control module 52 for developing the energy transfer prioritization control strategy 82 may include trailer-specific information 86 associated with each connected charging trailer 14 of the system 10. The trailer-specific information 86 may include information such as weight capacity, current content weight, and other relevant physical attributes of each connected charging trailer 14 of the system 10.

A third input that may be analyzed by the control module 52 for developing the energy transfer prioritization control strategy 82 may include real-time prognostic information 88 received from various components/subsystems of the electrified vehicle 12. The real-time prognostic information 88 may include information such as current location of the electrified vehicle 12 (e.g., GPS coordinates, cellular triangulation coordinates, etc.), notable landmarks or services (e.g., nearby charging stations, energy storage unit, other trailers to bidirectional energy transfer enabled vehicles, etc.), real-time travel elements such as the current traveling speed of the electrified vehicle 12 (e.g., distance and time measurements), current estimated time of arrival to reach destination/waypoint, etc.

A fourth input that may be analyzed by the control module 52 for developing the energy transfer prioritization control strategy 82 may include environmental information 90 received from the server system 54 and/or the GPS 48. The environmental information 90 may include current weather information along the drive route (e.g., received from the weather data server 60), current traffic information along the drive route (e.g., received from the traffic data server 62), physical route conditions (e.g., altitude/elevation conditions expected to be experienced along the drive route; received from the GPS 48), etc. Adverse traffic, weather, and/or physical route conditions can delay or slow the electrified vehicle 12 while traveling along the drive route and may therefore be important considerations that may affect the rate of charge when transferring charge energy during energy transfer events of the system 10.

A fifth input that may be analyzed by the control module 52 for developing the energy transfer prioritization control strategy 82 may include itinerary/calendar information 92 of the user associated with the electrified vehicle 12. The itinerary/calendar information 92 may include anticipated activity information such as upcoming drive routes planned by the user, frequently visited locations and expected arrival/departures times, home location and expected times parked at home location, scheduled activities of the user, etc. The itinerary/calendar information 92 may be received from the GPS 48 and/or from the server system 54 via the applications 64, 68. In an embodiment, an activity planner application of the personal electronic device 66 may be synced with the application 68 to provide an overall log of the user's anticipated activities in order to compliment the scheduled destination/waypoint indicated by the GPS 48. In another embodiment, the control module 52 may employ a neural network or machine learning techniques for inferring planned activities (e.g., learned driving habits or learned behaviors) that may occur during each planned drive route of the electrified vehicle 12.

A sixth input that may analyzed by the control module 52 for developing the energy transfer prioritization control strategy 82 may include user preference information 95 that may be pre-selected by the user associated with the electrified vehicle 12. The user preference information 95 may include pre-selected energy transfer settings/preferences such as minimum/maximum SOC levels (e.g., minimum transfer from charging trailer 14 of 25% SOC, etc), minimum/maximum vehicle range to enter/exit transfer (e.g., range reserve of at least 50 miles, etc.), preferred charging locations (e.g., home base, favorite public charging station, etc.), minimum/maximum total energy transfer amounts (e.g., maximum transfer of 100 W-h from electrified vehicle 12 to charging trailer 14, etc.), etc. The user preference information 95 may be received from the HMI 50 and/or from the server system 54 via the applications 64, 68, for example.

A seventh input that may be analyzed by the control module 52 for developing the energy transfer prioritization control strategy 82 may include recreational/industrial vehicle-specific information 85 associated with each connected electrified recreational/industrial vehicle 16 of the system 10. The recreational/industrial vehicle-specific information 85 may include information such various relevant physical attributes of each connected electrified recreational/industrial vehicle 16 of the system 10 (to the extent any are connected).

The inputs referenced above are intended to be exemplary only. Various other inputs could be considered by the control module 52 for developing the energy transfer prioritization control strategy 82 described herein.

In response to receiving and analyzing the various input signals, the control module 52 may prepare the energy transfer prioritization control strategy 82. As part of developing the energy transfer prioritization control strategy 82, the control module 52 may assign a priority ranking score to each electrified unit of the system 10. The assigned priority ranking score may be a number (e.g., an integer) that represents a priority ranking of the order in which charge energy from the one or more charging trailers 14 will be transferred to the electrified vehicle 12, or vice versa, at any given point in time during a bidirectional energy transfer event. In an embodiment, lower priority ranking scores indicate a lower priority for receiving charge energy at any given point of time during the energy transfer event, and higher priority ranking scores indicate a higher priority for receiving the charge energy at any given point of time during the energy transfer event.

In some instances, the priority ranking score for one or more of the charging trailers 14 and the electrified recreational/industrial vehicles 16 may be zero (0), indicating that a respective energy unit is free to transfer energy to other higher priority energy units. When all downstream energy units have a zero (0) priority ranking score, the downstream energy units may supply energy to the electrified vehicle 12.

The priority ranking score may be based on a variety of factors. In an embodiment, the priority ranking score for each available energy unit of the system 10 is based on a comparison of the available energy from each energy unit and the predicted energy needs of the energy unit. Differences between the available energy and the required energy for each energy unit may therefore be utilized as a basis for priority scoring within the energy transfer prioritization control strategy 82.

Another factor that may be relevant to assigning each priority ranking score may include the functional status of each electrified unit of the system 10. For example, energy transfer to a respective energy unit of the system 10 may be inhibited during error states of the electrified unit. Thus, when error states occur, the respective electrified unit experiencing the error state may be assigned a lower priority ranking score within the energy transfer prioritization control strategy 82.

Another factor that may be relevant to assigning each priority ranking score may include the energy requirements (e.g., updated prediction accuracy of energy required to complete drive route to destination/waypoint) of each electrified unit of the system 10. For example, the control module 52 may compare previous itinerary details and measured energy requirements with upcoming itinerary details and predicted energy requirements to identify any incompatibilities when assigning the priority ranking scores. Thus, electrified units that have higher expected energy requirements may be assigned a higher priority ranking score within the energy transfer prioritization control strategy 82.

Another factor that may be relevant to assigning each priority ranking score may include the physical/performance limitations of each energy unit of the system 10. For example, the control module 52 may determine whether or not each traction battery pack/energy storage device/system is physically capable of supporting energy transfers/loads. The control module 52 may review relevant battery management thresholds (e.g., thermal limitations, reduced charge acceptance, etc.) of the traction battery pack 28 and each energy storage system 30 as part of its analysis of performance limitations. Electrified units that have performance limitations may be assigned a lower priority ranking score within the energy transfer prioritization control strategy 82.

Yet another factor that may be relevant to assigning each priority ranking score may include conflicting user preference settings. The control module 52 may identify whether any user settings (e.g., settings made within the application 64 or the application 68) are incompatible with other settings of the system 10. For example, the control module 52 may compare a predicted drive route with a current drive direction (e.g., going off course in different direction, alternative plans, etc.) to identify whether any conflicts exist. Electrified units that have user preference settings that are in conflict with other settings of the system 10 may be assigned a lower priority ranking score within the energy transfer prioritization control strategy 82.

The factors referenced above are intended to be exemplary only. Various other factors could be considered by the control module 52 for assigning the priority ranking scores described herein.

The priority ranking scores of each electrified unit of the system 10 may be adjusted during energy transfer events based on various factors. In an embodiment, the priority ranking score of a particular energy unit may be adjusted based on a battery temperature associated with the energy unit. For example, when the battery temperature of the energy unit is outside of a predefined operational temperature window, the priority ranking score may be lowered. Battery temperatures that are completely outside the predefined operational temperature window may be result in lowering the priority ranking score by a first amount, and battery temperatures that are near a lower or upper boundary of the predefined operational temperature window may be incrementally lowered by a second, smaller amount.

In another embodiment, the time and distance to a desired destination/waypoint may be important factors that are considered for assigning/adjusting the priority ranking scores associated with each energy unit of the system 10. In another embodiment, the inferred use of each electrified unit may be considered for assigning/adjusting the priority ranking scores associated with each energy unit of the system 10 (e.g., priority ranking of one or more charging trailers 14 may be lowered if charging trailer is expected to be dropped off during the trip or when limited charge stations are expected to be available during the trip). In yet another embodiment, the priority ranking score for each energy unit of the system may be assigned/adjusted based on various user inputs that may specify a charging preference for one energy unit over other energy units of the system 10.

The control module 52 may be programmed to periodically update the priority ranking score assigned to each electrified unit of the system 10 each time a predefined time interval has lapsed. In an embodiment, the predefined time interval is about 10 minutes. However, other time intervals could alternatively be defined as the predefined time interval within the scope of this disclosure.

The control module 52 may further be programmed to command that one or more messages be displayed on the HMI 50 and/or the personal electronic device 66, for example, each time one of the priority ranking scores is adjusted or when reprioritization is deemed to be necessary. The control module 52 may also be configured to command that a message is displayed on the HMI 50 and/or the personal electronic device 66 when the current energy requirements of any of the electrified units of the system 10 are unable to be met under the current energy transfer conditions.

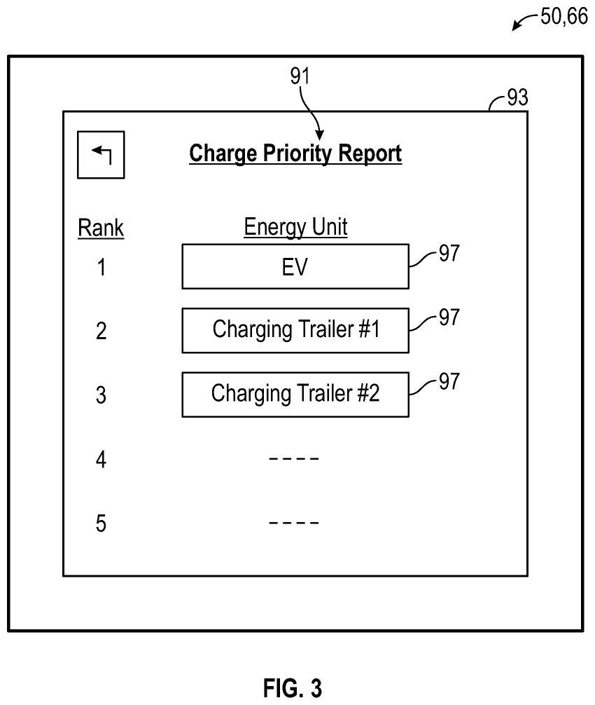

The control module 52 may further be programmed to command that a charge priority report 91 be displayed to the user on a user interface 93 associated with the HMI 50 and/or the personal electronic device 66 (see, e.g., FIG. 3). The charge priority report 91 may be derived from the energy transfer prioritization strategy 82, for example, and may list each energy unit of the system 10 in recommended order of charging priority for review by the user. The user may override the proposed order of charging priority by rearranging one or more tiles 97 within the user interface 93. Each tile 97 may be associated with one of the connected energy units of the system 10. Other configurations are also contemplated for displaying the charge priority report 91 to the user and for allowing the user to override the recommended charge priority order.

The control module 52 may further be programmed to communicate/interface with the various energy units of the system 10 in order to execute the energy transfer prioritization control strategy 82. For example, the energy transfer prioritization control strategy 82 may indicate how much (including charge rate), if any, and when charge energy should be transferred from the energy storage systems 30 of the charging trailers 14 to the traction battery pack 28 of the electrified vehicle 12 and/or to the energy storage systems 30 of other charging trailers 14, and how much, if any, and when charge energy should be transferred from the traction battery pack 28 of the electrified vehicle 12 to the energy storage system 30 of the one or more charging trailers 14. The control module 52 may therefore interface with and control the functionality of the bidirectional power transfer system 40 (e.g., by opening/closing contactors, performing step-up or step-down power conversions, performing power inversions, etc.) and any other related systems/subsystems for coordinating and providing prioritized energy transfers to the energy units of the system 10 during energy transfer events.

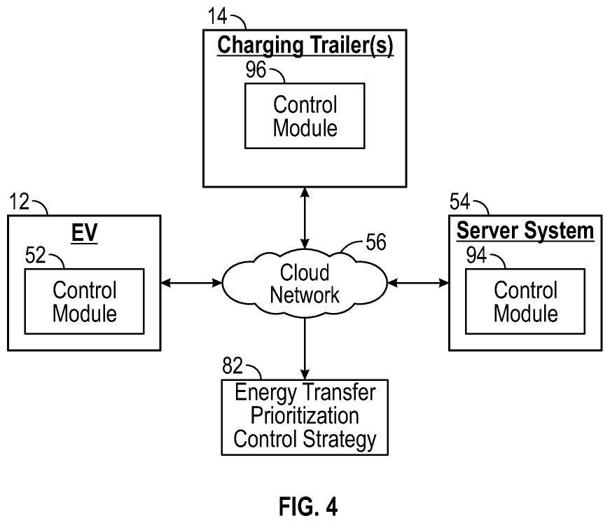

In the embodiments described above, the control module 52 of the electrified vehicle 12 may be configured to function as the communications hub of the system 10. However, other embodiments are also contemplated within the scope of this disclosure. For example, as schematically shown in FIG. 4, a control module 94 of the server system 54 (e.g., a cloud-based control module) or a control module 96 associated with each connected charging trailer 14 could be configured to function as the communications hub of the system 10. In yet another embodiment, the respective control modules of each of the electrified vehicle 12, the one or more charging trailers 14, and the server system 54 may operate together over the cloud network 56 to establish a control system for preparing the energy transfer prioritization control strategy 82 and for ultimately controlling the energy transfer prioritization afforded by the system 10.

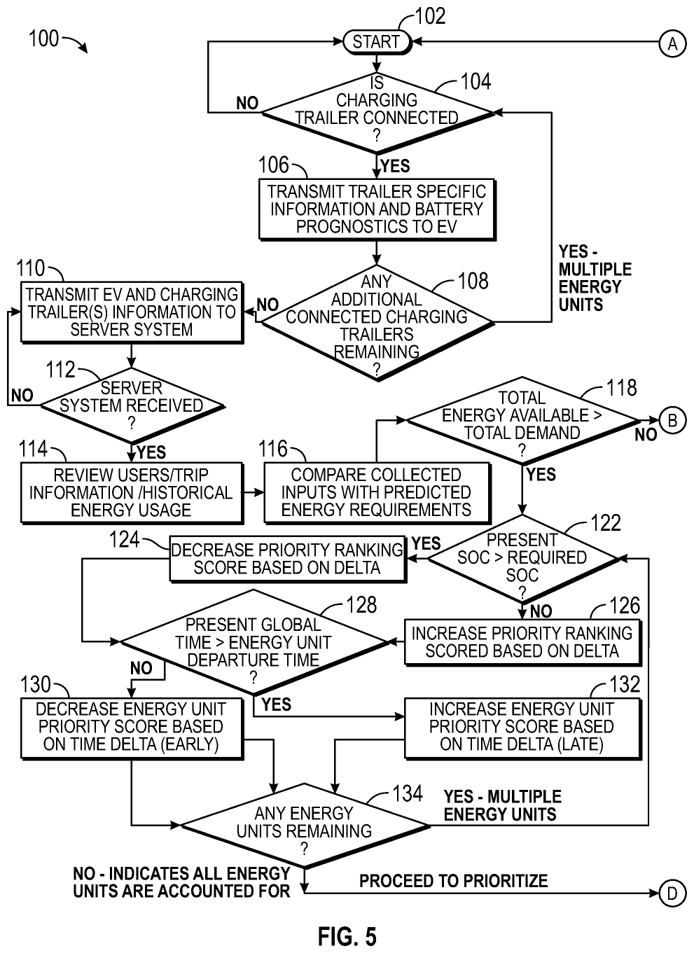

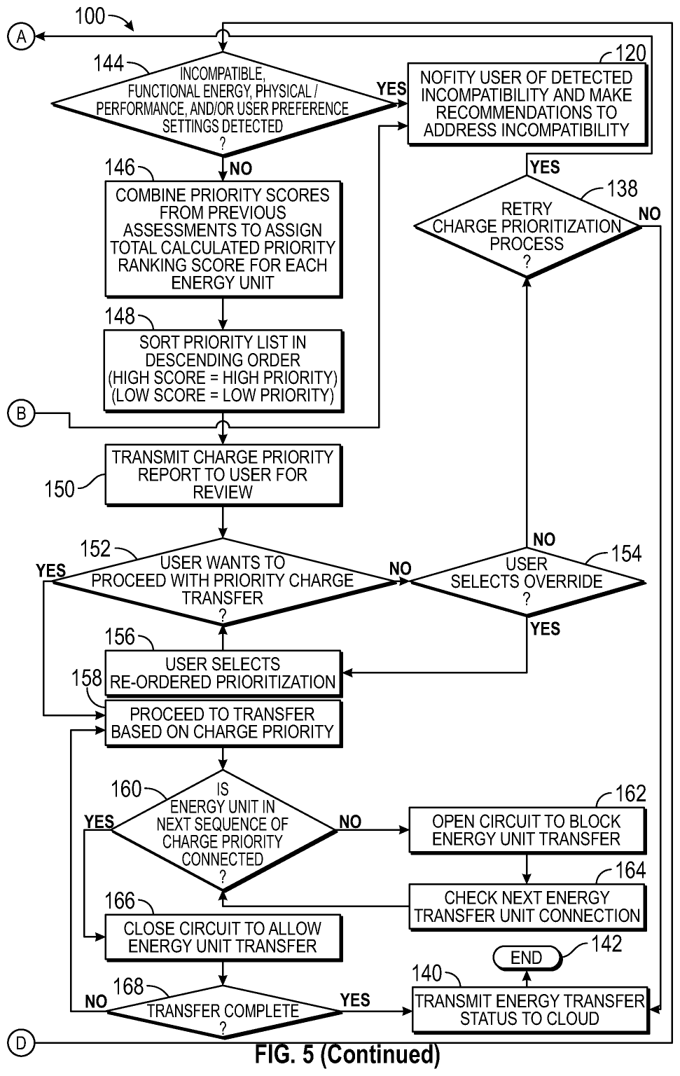

FIG. 5, with continued reference to FIGS. 1-4, schematically illustrates in flow chart form an exemplary method 100 for creating and executing the energy transfer prioritization control strategy 82 of the system 10. Per the method 100, the energy transfer prioritization control strategy 82 may be executed to provide prioritized energy transfers between the electrified vehicle 12 and the one or more charging trailers 14, for example.

The system 10 may be configured to employ one or more algorithms adapted to execute at least a portion of the steps of the exemplary method 100. For example, the method 100 may be stored as executable instructions in the memory 80 of the control module 52, and the executable instructions may be embodied within any computer readable medium that can be executed by the processor 78 of the control module 52. The method 100 could alternatively or additionally be stored as executable instructions in the memories of comparable control modules of the one or more charging trailers 14 and/or the server system 54.

The exemplary method 100 may begin at block 102. At block 104, the method 100 may determine whether one or more charging trailers 14 are connected to the electrified vehicle 12. If YES, the method 100 may proceed to block 106 by transmitting the trailer-specific information 86 and the battery prognostic information 84 from each charging trailer 14 to the control module 52 of the electrified vehicle 12.

Next, at block 108, the method 100 may confirm whether any connected charging trailers 14 remain that have not been accounted for. If a NO flag is returned, the method 100 may proceed to block 110. At block 110, various information from the electrified vehicle 12 and from each connected charging trailer 14 may be transmitted to the server system 54 for further analysis. The information transmitted to the server system 54 may include, but is not limited to, the battery prognostic information 84, the trailer-specific information 86, the real time prognostic information 88, etc. The method 100 may confirm that the information has been received by the server system 54 at block 112. If YES, the method 110 may next review planned trip information (such as from the GPS 48) and the user's historical energy usage of the electrified vehicle 12 at block 114. This may include accounting for available grid power until time of departure to calculate the total energy supply of the electrified vehicle 12.

At block 116, the method 100 may compare the collected inputs with the predicted energy requirements of each connected energy unit of the system 10. This step may include accessing the total energy unit demand and the total energy unit supply for each energy unit of the system 10. The method 100 may then proceed to block 118 by determining whether the total energy available from each energy unit of the system 10 exceeds the total energy demand of the energy unit. If NO, the method 100 may proceed to block 120 (further discussed below). If YES, the method 100 may proceed to block 122.

Assuming the method 100 proceeds to block 122 from block 118, the method 100 may next determine whether the current SOC of each energy unit of the system 10 exceeds the required SOC for that respective energy unit. If YES, the priority ranking score for the respective energy unit may be decreased at block 124. If NO, the priority ranking score for the energy unit may be increased at block 126. The amount of the priority score increase/decrease may be scaled based on the magnitude of the difference between the current SOC and the required SOC for each energy unit.

Next, at block 128, the method 100 may determine whether the current time is greater than an expected departure time of the electrified vehicle 12 of the system 10. IF NO, the priority ranking score may for the energy unit may be decreased at block 130. If YES, the priority ranking score for the energy unit may be increased at block 132. The amount of the priority score increase/decrease may be scaled based on the magnitude of the difference between the current time and the expected departure time.

The method 100 may next confirm whether any connected energy units of the system 10 remain to be accounted for at block 134. If YES, the method 100 may return to block 122 to account for any of the remaining energy units. If NO, the method 100 may instead proceed to block 144 by determining whether any incompatible functional requirement, energy requirement, physical performance requirement, and/or user preference/setting has been detected. If YES, the method 100 proceeds to block 120. At this step, the method 100 may notify the user of any detected incompatibilities and provide recommendations for fixing the incompatibilities. The method 100 may then receive indication from the user whether or not to retry the charge prioritization process at block 138. If YES, the method may return to block 102. If NO, the method may proceed to block 140 by saving the actual energy transfer measurements to the cloud. The method 100 may then end at bock 142.

If a NO flag is returned at block 144, the method 100 may instead proceed to block 146. At block 146, the various priority scores from the previous energy unit assessments (see, e.g., blocks 122-134) may be aggregated. Each aggregated score may be assigned as the priority ranking score for each connected energy unit of the system 10.

Next, at block 148, the method 100 may sort the priority ranking scores of the energy units in descending order of highest score to lowest score (e.g., higher scores are of higher priority for receiving charge energy and lower scores are of lower priority for receiving charge energy). The charge priority report 91, which lists the energy units in order of ranking, may then be transmitted to the user at block 150.

The method 100 may confirm whether the user desires to proceed with the recommended priority charge transfer indicated by the charge priority report 91 at block 152. If NO, the method 100 may confirm whether the user has selected a priority override at block 154. If YES, the method 100 may receive a user input of the re-ordered prioritization at block 156. The method 100 may instead proceed to block 138 (discussed above) if the user has not selected an override at block 154. Alternatively, if a YES flag is returned at block 152, the method 100 may proceed with the recommended energy transfers based on the various priority ranking scores at block 158.

Next, a block 160, the method 100 confirms whether the energy unit (or units) in the next sequence of charge priority is connected to the system 10. If NO, the charge circuit is opened (e.g., by controlling the bidirectional power transfer system 40) to block energy transfer to the energy unit at block 162. The user may then be prompted to address the energy unit connection at block 164. Alternatively, if a YES flag is returned at block 160, the charge circuit may be opened (e.g., by controlling the bidirectional power transfer system 40) to allow energy transfer between the electrified vehicle 12 and the energy unit at block 166.

The method 100 may confirm whether the energy transfer is complete at block 168. The actual energy transfer measurements performed may be saved to the cloud at block 140 when the transfer is confirmed as being completed. The method 100 may then end at bock 142.

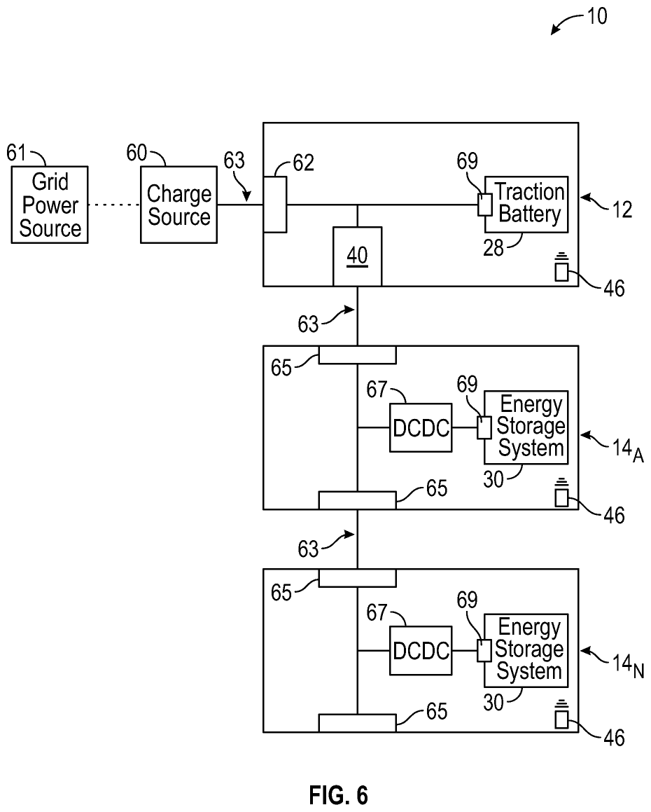

Referring now to primarily to FIG. 6, a bidirectional energy transfer system 10 may be operably coupled to a charge source 60 in some implementations, such as during energy transfer events that occur while the structures of the system 10 are stationary or not “in-flight.” The charge source 60 may be a public charging station, a DC fast charging station, a home charging station, a wall box, or any other type of charge source. The charge source 60 may be operably coupled to a grid power source 61 (e.g., AC power, solar power, wind power, or combinations thereof). The charge source 60 may therefore provide the interface for charging the energy units of the system 10 using power supplied by the grid power source 61.

The electrified vehicle 12 may be equipped with a charge port assembly 62 that is configured to receive energy from the charge source 60. A charging cable 63 may be used to connect the charge source 60 to the charge port assembly 62.

Each charging trailer 14 may be equipped with two or more charge port assemblies 65. Two or more charge port assemblies 65 may be provided such that each charging trailer 14 of the system 10 may be configured to send/receive charge energy to/from an upstream energy unit and/or a downstream energy unit of the system 10.

Additional charging cables 63 may be used to operably connect the charging trailers 14 to one another and to the electrified vehicle 12 and thus the charge source 60. The charging cables 63 may be arranged in a daisy-chain configuration for transferring energy during bidirectional energy transfer events.

As referenced above, the bidirectional power transfer system 40 may be controlled to allow energy transfers to/from downstream energy units of the system 10. Each charging trailer 14 may also be equipped with a DC-DC converter 67 that is configured to perform various functions during energy transfers, such as performing step-up or step-down power conversions, controlling the direction of power transfer to/from the energy storage unit 30, etc.

The system 10 may determine what energy units are connected to the electrified vehicle 12 in various ways in order for enabling proper bidirectional power flow. In an embodiment, the user may manually specify what energy units are connected by leveraging various user interfaces of the HMI 50 and/or the personal electronic device 66. In another embodiment, each charge port assembly 62, 65 may be equipped with various sensors that are capable of detecting when connections are made and then communicating with the control module 52 in response thereto. In yet another embodiment, the electrified vehicle 12 and the charging trailers 14 are capable of wirelessly communicating with one another via telecommunications modules 46 that can be provided on each subunit of the system 10. In such an embodiment, a contactor system 69 of each charging trailer 14 and of the traction battery pack 28 may be turned on/off to determine where power is flowing within the system 10. The power flow information may then be wirelessly transmitted between the various subunits of the system 10 via the telecommunications modules 46.

The bidirectional energy transfer systems of this disclosure are designed to coordinate and control, in a semi-automated manner, power flow during energy transfer events between an electrified vehicle and one or more charging trailers that are operably coupled to the electrified vehicle. The systems and methods may prioritize energy transfers between each connected energy unit of the system based on various input parameters in order to enable closed-loop energy transfer feedback, and for addressing charge uniformity and battery thermal issues from competing battery thermal management systems. The proposed systems and methods may better manage energy flow between the connected energy units for achieving streamlined decision making during bidirectional energy transfers.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A bidirectional energy transfer system, comprising:
an electrified vehicle;
a charging trailer operably coupled to the electrified vehicle; and
a control module programmed to create an energy transfer prioritization control strategy for controlling a transfer of energy between the electrified vehicle and the charging trailer during an energy transfer event.

2. The system as recited in claim 1, comprising an electrified recreational/industrial vehicle operably coupled to the charging trailer.

3. The system as recited in claim 2, wherein the control module is further programmed to control a transfer of energy from at least one of the charging trailer or the electrified vehicle to the electrified recreational/industrial vehicle during the energy transfer event.

4. The system as recited in claim 1, wherein the control module is further programmed to interface with a bidirectional power transfer system of the electrified vehicle for controlling the transfer of the energy between the charging trailer and the electrified vehicle according to the energy transfer prioritization control strategy during the energy transfer event.

5. The system as recited in claim 1, wherein the control module is a component of the electrified vehicle.

6. The system as recited in claim 1, wherein the control module is a component of a cloud-based server system.

7. The system as recited in claim 1, wherein the energy transfer prioritization control strategy includes a first priority ranking score assigned to a traction battery pack of the electrified vehicle and a second priority ranking score assigned to an energy storage system of the charging trailer.

8. The system as recited in claim 7, wherein the energy transfer prioritization control strategy includes a third priority ranking score assigned to either a second charging trailer or an electrified recreational/industrial vehicle that is operably coupled to the charging trailer.

9. The system as recited in claim 1, wherein the energy transfer prioritization control strategy is derived based on battery prognostic information associated with a traction battery pack of the electrified vehicle and an energy storage system of the charging trailer.

10. The system as recited in claim 9, wherein the energy transfer prioritization control strategy is further derived based on environmental information and/or itinerary/calendar information associated with a user of the electrified vehicle.

11. An electrified vehicle, comprising:
a traction battery pack; and
a control module programmed to create an energy transfer prioritization control strategy for controlling a transfer of energy from the traction battery pack to a separate energy unit or from the separate energy unit to the traction battery pack during an energy transfer event.

12. The electrified vehicle as recited in claim 11, wherein the energy transfer prioritization control strategy includes a priority ranking score assigned to the traction battery pack.

13. The electrified vehicle system as recited in claim 11, wherein the energy transfer prioritization control strategy is derived based on battery prognostic information associated with the traction battery pack.

14. The electrified vehicle system as recited in claim 11, wherein the energy transfer prioritization control strategy is derived based on real-time prognostic information associated with the electrified vehicle.

15. The electrified vehicle as recited in claim 11, wherein the energy transfer prioritization control strategy is derived based on itinerary/calendar information associated with a user of the electrified vehicle.

16. The electrified vehicle system as recited in claim 11, wherein the energy transfer prioritization control strategy is derived based on a real-time weather condition.

17. The electrified vehicle system as recited in claim 11, wherein the energy transfer prioritization control strategy is derived based on a real-time traffic condition.

18. The electrified vehicle system as recited in claim 11, wherein the energy transfer prioritization control strategy is derived based on user preference information that is pre-selected by a user of the electrified vehicle.

19. The electrified vehicle system as recited in claim 11, wherein the control module is further programmed to transmit a charge priority report to a user of the electrified vehicle in anticipation of the energy transfer event.

20. The electrified vehicle system as recited in claim 19, wherein the control module is further programmed to receive an input from the user indicating a modification to the charge priority report.
